(19) United States
(12) Patent Application Publication
(10) Pub. No.: US 2020/0341966 A1
(43) Pub. Date: Oct. 29, 2020

(54) System and Method of Aggregating Domain Name System Monitoring Data

(71) Applicant: International Business Machines Corporation, Armonk, NY (US)

(72) Inventors: Marc P. Stoecklin, White Plains, NY (US); Cheng-Ta Lee, Taipei City (TW); Jacobus P. Lodewijkx, Oakton, VA (US); Russell Couturier, Worcester, MA (US); Douglas L. Schales, Ardsley, NY (US); Andrii Iesiev, Northampton, MA (US)

(21) Appl. No.: 16/396,201

(22) Filed: Apr. 26, 2019

(51) Int. Cl. G06F 16/23; G06F 16/25

(52) U.S. Cl. CPC G06F 16/2365; G06F 16/258; G06F 16/2379

(57) ABSTRACT

A method, system and computer-usable medium are disclosed for obtaining domain name system (DNS) monitoring data. A DNS data collector that can be either part of a local network or part of an external network is implemented. The DNS data collector receives and collects logs from DNS transactions collected from various sources that include DNS resolvers, DNS servers, and DNS aggregator, which can be part of a local network or can be part of an external network. The DNS data collector determines if the DNS logs are missing any data related to the DNS transactions. The missing DNS data is looked up and the DNS logs are completed. Completed DNS logs can then be sent for analysis, such as for DNS traffic threats.

### BACKGROUND OF THE INVENTION

### Field of the Invention

The present application relates generally to an improved data processing system and method, and more specifically for mechanisms to obtain domain name system (DNS) monitoring data.

### Description of the Related Art

DNS systems allow network clients (i.e., computers and devices) to convert domain names into Internet Protocol (IP) addresses. As part of a network operation, computers and other devices (e.g., endpoint devices) generally need to know each other's IP address in order to communicate over a network. For example, when a device is provided with a web link, the device issues a DNS request asking for the IP address that corresponds to that address. The DNS system responds with the corresponding IP address, allowing the device to communicate with the server(s) that hosts the site related to the web link.

Monitoring DNS traffic is crucial to maintain network and device security. DNS traffic in a local network can be a critical source of data for valuable threat intelligence. Typical approaches to monitor local DNS traffic can involve modifications to an existing local network topology. For example, an existing DNS server can be replaced, or new local DNS server can be added, that captures full DNS traffic transactions. Alternatively, a network monitor can be installed to observe network traffic directly. Given that a DNS system provides a critical network service, changes to an existing DNS system infrastructure, or changes to an existing local network topology, can present unwelcomed challenges for administrators, such as an information technology (IT) team.

Other solutions can involve a less intrusive approach in obtaining DNS traffic monitoring data. A solution for local DNS traffic visibility is to collect logs from an existing DNS server. A configuration modification of an existing DNS server can be made to forward logs of the DNS server to a log aggregator. Such an approach yields less information than what can be obtained by capturing a full DNS traffic stream. The typical DNS resolver logs basic information about the transaction, and information can be lost in the process. For example, such DNS logs typically do not include the full request and response data records, such as a text (TXT) record. Such information can be critical for detecting DNS based attacks such as tunneling. Therefore, there is a desire to provide for a solution that does not change local network topology nor affect DNS settings, but can still provide valuable DNS transaction information in order to support DNS traffic analytics, such as threat analytics.

### SUMMARY OF THE INVENTION

A method, system and computer-usable medium are disclosed for obtaining domain name system (DNS) monitoring data. DNS logs from DNS transactions are collected from various sources that include DNS resolvers, DNS servers and DNS aggregators. The DNS resolvers, DNS servers and DNS aggregators can be part of a local network or can be part of an external network. A determination is made if the DNS logs are missing any data related to the DNS transactions. The missing DNS data is looked up and the DNS logs are completed. Completed DNS logs can then be sent for analysis, such as for DNS traffic threats.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a system for a domain name system (DNS) and used to obtain DNS monitoring data;

FIG. 2 is a block diagram of an information processing system capable of performing computing operations;

FIG. 3 is a block diagram of a domain name system (DNS) data collector;

FIG. 4 depicts a domain name system (DNS) data monitoring system configure to receive DNS logs directly from a local DNS resolver;

FIG. 5 depicts a domain name system (DNS) data monitoring system to receive DNS logs from a DNS log aggregator, such as a security information and event management (SIEM) component/system,

FIG. 6 depicts a domain name system (DNS) data monitoring system that includes a DNS data collector in an external network.

FIG. 7 depicts a domain name system (DNS) data monitoring system that includes a DNS data collector in an external network, and a local DNS log aggregator, such as a security information and event management (STEM) component/system;

FIG. 8 is a generalized flowchart of the operation for obtaining domain name system (DNS) monitoring data.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carry, Mg out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In certain implementations, the described system, method or computer program product use an asynchronous approach to compose the DNS visibility used by analytics (e.g., DNS traffic analytics, such as threat analytics). DNS data streams can include DNS traffic and DNS logs (i.e., DNS data). Typical approaches rely on a single data stream to collect comprehensive DNS data. In certain implementations, the described system, method or computer program product can supplement an incomplete DNS log data by actively or periodically querying a DNS server to collect missing information. A DNS data collector as described herein, can be used to implement such an asynchronized mechanism. In certain implementations, the DNS data collector can run locally or run as a service, such as a service in the “cloud.” A DNS server is queried and can be an existing local DNS server that provides DNS logs, or in certain implementations, the DNS server can be a global DNS server.

In certain implementations, a local existing DNS data collector queries a local existing DNS server that provides DNS logs, where the query is directed to determine missing DNS context (information). Such queries are expected to be for a relatively small subset of DNS requests which can be considered as suspicious; however, most DNS requests can be immediately categorized as not suspicious. Therefore, in certain implementations, a small subset of DNS logs (i.e., subset of DNS requests considered to be suspicious) would be completed. Such queries can be served out of a cache of the local DNS resolver, such that no additional outbound traffic is generated. The local existing DNS data collector can combine the data obtained through the DNS logs with results from the asynchronous query to construct a full view of a DNS transaction. The DNS transaction can then be exported to a DNS analyzer. The DNS analyzer can include analytic modules, and can be run remotely.

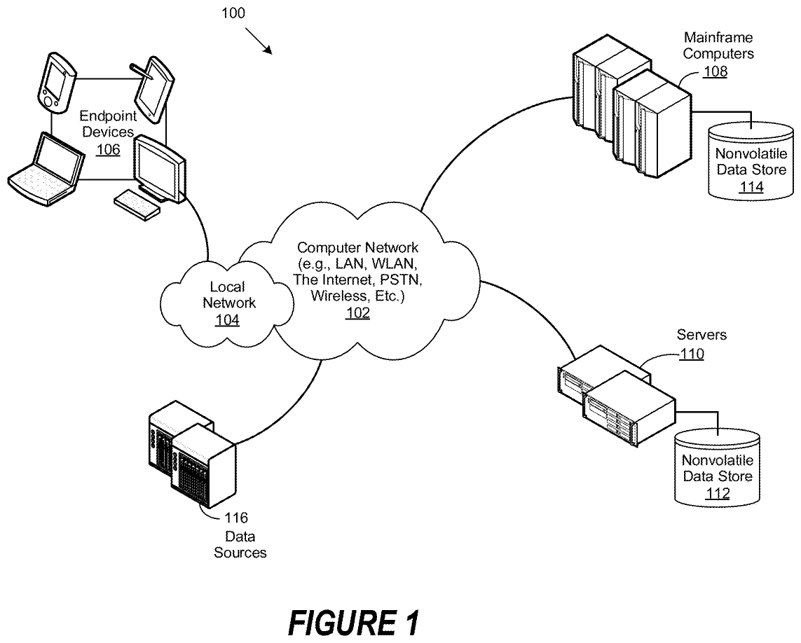

FIG. 1 is a generalized illustration of a system 100 that can be used to implement the system and method of the present invention. In certain embodiments, the system 100 provides for a domain name system (DNS) and can be implemented obtain DNS monitoring data.

The system 100 includes a network 102 which can include Local Area Networks (LANs), Wireless Local Area Networks (WLANs), the Internet, the Public Switched Telephone Network (PSTN), other wireless networks. Network 102 can further include other network topology that can be used to interconnect the elements of system 100. Network 102 can also include “cloud” networks. In various embodiments, network 102 includes various local networks 104 which implement DNS traffic.

DNS traffic can include DNS traffic from various endpoint devices 106 that are part of the system 100. The endpoint devices 106 can be in communication with each other and with other devices or components via one or more wired and/or wireless data communication links, where each communication link may comprise one or more of wires, routers, switches, transmitters, receivers, or the like. In certain implementations, the endpoint devices 106 are considered part of local network 104. An endpoint device 106, as likewise used herein, refers to an information processing system such as a personal computer, a laptop computer, a tablet computer, a personal digital assistant (PDA), a smart phone, a mobile telephone, a digital camera, a video camera, or other device that is capable of storing, processing and communicating data. In certain embodiments, the communication of the data may take place in real-time or near-real-time. As used herein, real-time broadly refers to processing and providing information within a time interval brief enough to not be discernable by a user. As an example, a cellular phone conversation may be used to communicate information in real-time, while an instant message (IM) exchange may be used to communicate information in near real-time. In certain embodiments, the communication of the information may take place asynchronously. For example, an email message may be stored on an endpoint device 106 when it is offline. In this example, the information may be communicated to its intended recipient once the endpoint device 106 gains access to a network 102.

The system 100 can further include other information processing systems that can be used for specific functionality, such as to support a DNS system and obtain DNS monitoring data. In certain embodiments, such information processing system can be dedicated mainframe computers (i.e., computers) 108 and server computers 110. In certain implementations, the mainframe computers 108 and server computers 110 are included in local network(s) 104, and in certain implementations, the mainframe computers 108 and server computers 110 are included in external networks.

Some of the information processing systems shown in FIG. 1 depict separate nonvolatile data stores, server 110 utilizes nonvolatile data store 112, and mainframe computer 108 utilizes nonvolatile data store 114. The nonvolatile data store can be a component that is external to the various information processing systems or can be internal to one of the information processing systems. In certain implementations, separate data sources 116 are included in system 100.

In certain implementations, mainframe computers 108 and server computers 110 can be implemented as “nameservers” that are external to a local network 104. Endpoint devices 106 can include at least one DNS resolver (not shown) which can send DNS requests to a DNS server (not shown). If the DNS server is a DNS forwarding serve, then the DNS requests can be forward to a recursive DNS server which can contact authoritative “nameservers” to get the necessary IP address information (i.e., IP address) through DNS requests. A “nameserver” is a server that holds the IP address information and IP address. In certain instances, such DNS requests can involve numerous nameservers throughout the world. In certain implementations, mainframe computers 108 and server computers 110 can be implemented by various sites to provide content to endpoint devices 106. With the proper IP address, endpoint devices 106 communicate with mainframe computers 108 and server computers 110 that are implemented by various sites.

In certain implementations, mainframe computers 108 and server computers 110 can be implemented as DNS specific information processing systems, such as DNS resolvers, DNS servers (e.g., forwarding DNS server, DNS recursive servers), collectors, DNS analyzers, and DNS aggregators, where DNS aggregators can be included as part of security information and event management (SIEM) component/system (not shown). Such DNS specific information processing systems are further discussed below.

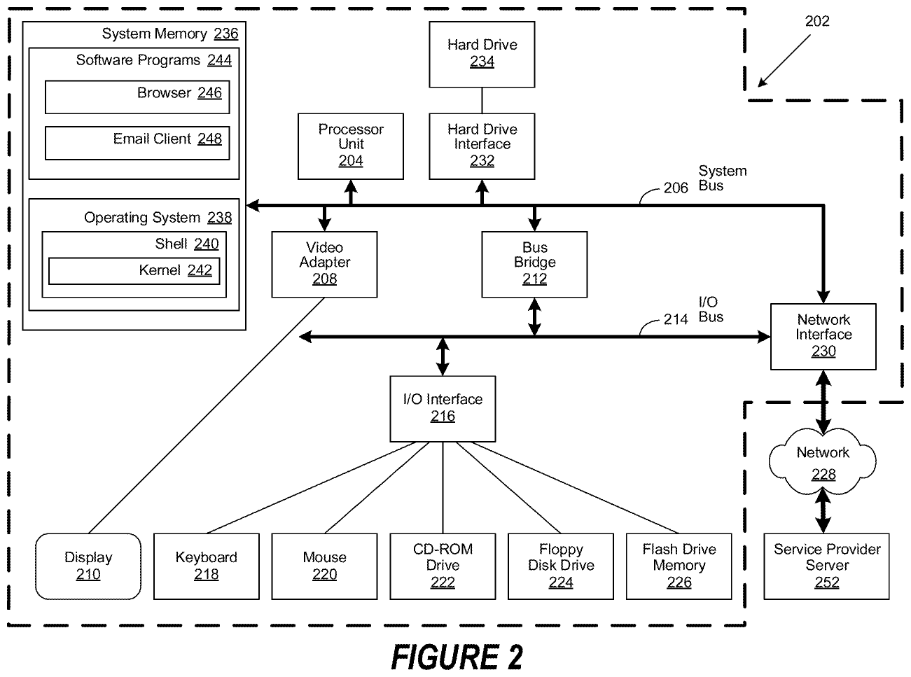

FIG. 2 illustrates an information processing system 202, more particularly, a processor and common components, which is a simplified example of a computer system capable of performing the computing operations described herein. For example, the described endpoint devices 106, mainframe computers 108 and server computers 110 can be implemented as information processing system 202.

Information processing system 202 includes a processor unit 204 that is coupled to a system bus 206. A video adapter 208, which controls a display 210, is also coupled to system bus 206. System bus 206 is coupled via a bus bridge 212 to an Input/Output (I/O) bus 214. An I/O interface 216 is coupled to I/O bus 214. The I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports. The information processing system 202 is able to communicate with a service provider server 238 via network 102 using a network interface 230, which is coupled to system bus 206.

A hard drive interface 232 is also coupled to system bus 206. Hard drive interface 232 interfaces with a hard drive 234. In a preferred embodiment, hard drive 234 populates a system memory 236, which is also coupled to system bus 206. Data that populates system memory 236 includes the information processing system's 202 operating system (OS) 238 and software programs 244.

OS 238 includes a shell 240 for providing transparent user access to resources such as software programs 244. Generally, shell 240 is a program that provides an interpreter and an interface between the user and the operating system. More specifically, shell 240 executes commands that are entered into a command line user interface or from a file. Thus, shell 240 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. While shell 240 generally is a text-based, line-oriented user interface, the present invention can also support other user interface modes, such as graphical, voice, gestural, etc.

As depicted, OS 238 also includes kernel 242, which includes lower levels of functionality for OS 238, including essential services required by other parts of OS 238 and software programs 244, including memory management, process and task management, disk management, and mouse and keyboard management. Software programs 244 may include a browser 246 and email client 248. Browser 246 includes program modules and instructions enabling a World Wide Web (WWW) client (i.e., information processing system 202) to send and receive network messages to the Internet using Hyper Text Transfer Protocol (HTTP) messaging, thus enabling communication with service provider server 228.

The hardware elements depicted in the information processing system 202 are not intended to be exhaustive, but rather are representative to highlight components used by the present invention. For instance, the information processing system 202 may include alternate memory storage devices such as magnetic cassettes, Digital Versatile Disks (DVDs), Bernoulli cartridges, and the like. These and other variations are intended to be within the spirit, scope and intent of the present invention.

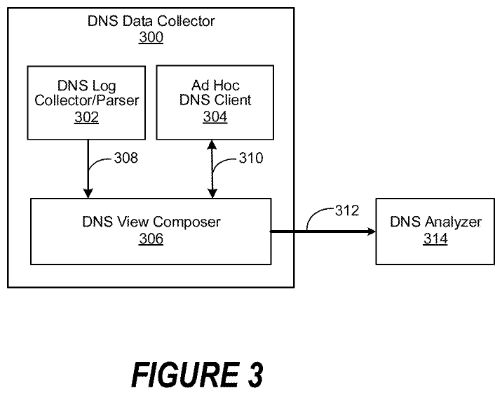

FIG. 3 illustrates a DNS data collector. DNS data collector 300 can run locally or run as a service, such as a service in the “cloud.” In certain implementations, the DNS collector 300 includes three components, a DNS log collector/parser 302, an Ad Hoc DNS client 304, and a DNS view composer 306.

The DNS log collector/parser 302 can be configured to receive and process DNS logs from a local DNS server (not shown), and/or from DNS log aggregators (not shown). DNS log aggregators can be on a local network or external (e.g. cloud based) and can be part of a security information and event management or SIEM system/component. The DNS log collector/parser 302 can be further configured to convert DNS logs from various DNS log sources to a common data format processable by other components.

The Ad Floc DNS client 304 can be configured to receive DNS queries and repeats the DNS queries to the local DNS server (not shown). Once the Ad Hoc DNS client 304 receives a response from the local DNS server (not shown), the Ad Hoc DNS client 304 can parse the transaction and convert the response to a common data format that can be processed by other components.

The DNS view composer 306 receives data 308 from the DNS log collector/parser 302 and looks for/determines missing DNS information. Policy/configuration can be applied to the DNS view composer 306, where such policy/configuration prioritizes DNS transactions with any missing DNS information. The DNS view composer 306 can trigger 310 the Ad Hoc DNS client 304 to retrieve 310 full context of DNS transactions. Once the Ad Hoc DNS client 304 returns the DNS missing information, the DNS view composer 306 creates a comprehensive view of the DNS transaction. The DNS view composer 306 exports the DNS data stream 312 to a DNS analyzer 314 for analysis (e.g., DNS traffic analytics, such as threat analytics). The DNS analyzer 314 can be run remotely.

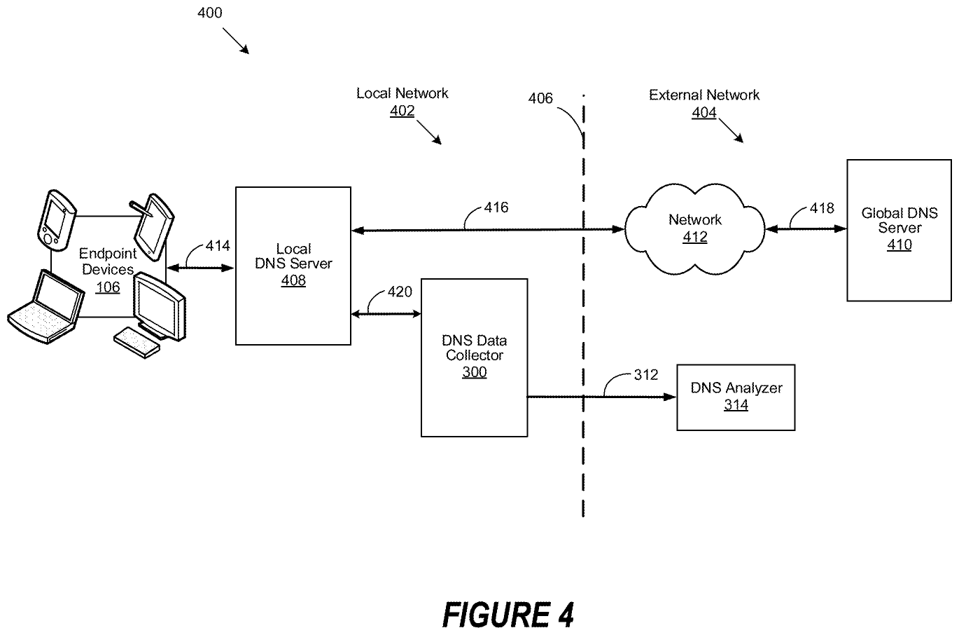

FIG. 4 illustrates a DNS data monitoring system to receive DNS logs directly from a local DNS server. In certain implementations, the DNS data monitoring system 400 includes a local network 402 and an external network 404, as defined by line 406. Local network 402 can include customer networks. External network 404 can include the Internet. The local network 402 can include endpoint devices 106 and a local DNS server 408, where the local DNS server 408 can be an existing DNS server that is a part of the local network 402. The external network 404 includes a global DNS server 410. The global DNS server 410 can be included or connected to a network 412. In certain implementations, the network 412 can be a cloud network. In this implementation, the local network 402 includes DNS data collector 300. The external network 404 includes the DNS analyzer 314.

In certain implementations, data flow for the DNS data monitoring system 400 is as follows. Endpoint devices 106 make DNS requests 414 to the local DNS server 408. DNS requests 414 include requests for an IP address, where the DNS server 408 contacts multiple authoritative “nameservers” to get the necessary IP address information. The local DNS server 408 forwards 416 the DNS requests to network 412, which forwards 418 requests to the global DNS server 410. The global DNS server 410 returns 418 and 416 results (e.g., IP addresses) to the local DNS server 408. The local DNS server 408 provides logs 420 to the DNS data collector 300. The DNS data collector 300 actively or periodically queries 420 the local DNS server 408 for missing DNS information. The DNS data collector 300 forwards DNS data stream 312 to a DNS analyzer 314 for analysis (e.g., DNS traffic analytics, such as threat analytics).

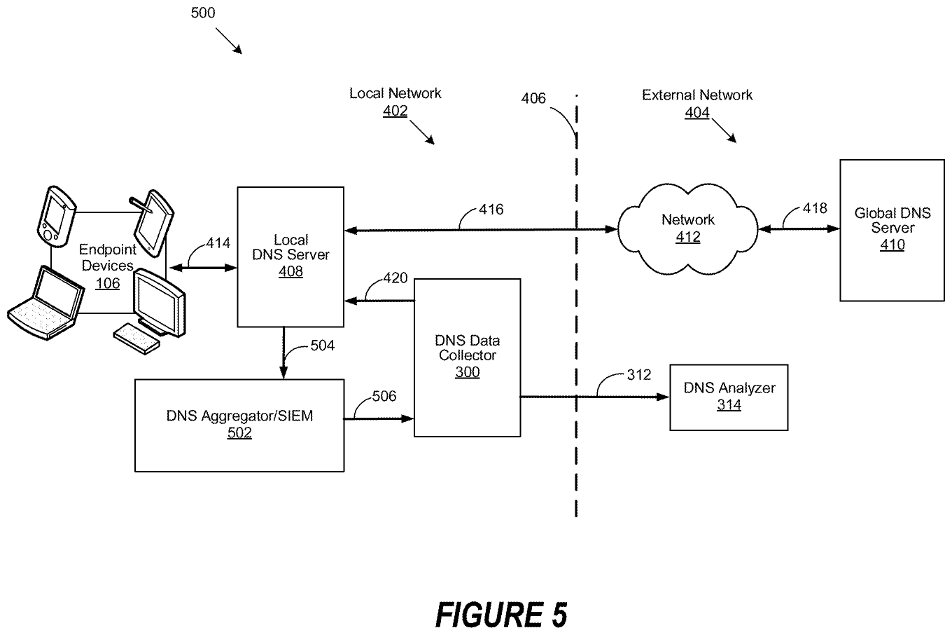

FIG. 5 illustrates a DNS data monitoring system to receive DNS logs from a DNS log aggregator, such as a SIEM. In certain implementations, the DNS data monitoring system 500 includes local network 402 and external network 404, as defined by the line 406. Local network 402 can include customer networks. External network 404 can include the Internet. The local network 402 can include endpoint devices 106 and local DNS server 408, where the local DNS server 408 can be an existing DNS server that is a part of the local network 402. The external network 404 includes a global DNS server 410. The global DNS server 410 can be included or connected to network 412. In certain implementations, the network 412 can be a cloud network. In this implementation, the local network 402 includes DNS data collector 300. The external network 404 includes the DNS analyzer 314. The DNS monitoring system 500 further includes DNS Aggregator/SIEM 502 which can be a separate DNS Aggregator, or a security information and event management or SIEM system/component that includes a DNS Aggregator(s).

In certain implementations, data flow for the DNS data monitoring system 500 is as follows. Endpoint devices 106 make DNS requests 414 to the local DNS server 408. DNS requests 414 include requests for an IP address, where the DNS server 408 contacts multiple authoritative “nameservers” to get the necessary IP address information. The local DNS server 408 forwards 416 the DNS requests to network 412, which forwards 418 requests to the global DNS server 410. The global DNS server 410 returns 418 and 416 results (e.g., IP addresses) to the local DNS server 408. The local DNS server 408 provides the results 414 to the requesting endpoint devices 106. The local DNS server 408 provides logs 504 to the DNS Aggregator/SIEM 502. DNS data collector 300 collects DNS data 506 from the DNS Aggregator/SIEM 502 and actively queries 420 the local DNS server 408 for missing DNS information. The DNS data collector 300 forwards DNS data stream 312 to a DNS analyzer 314 for analysis (e.g., DNS traffic analytics, such as threat analytics).

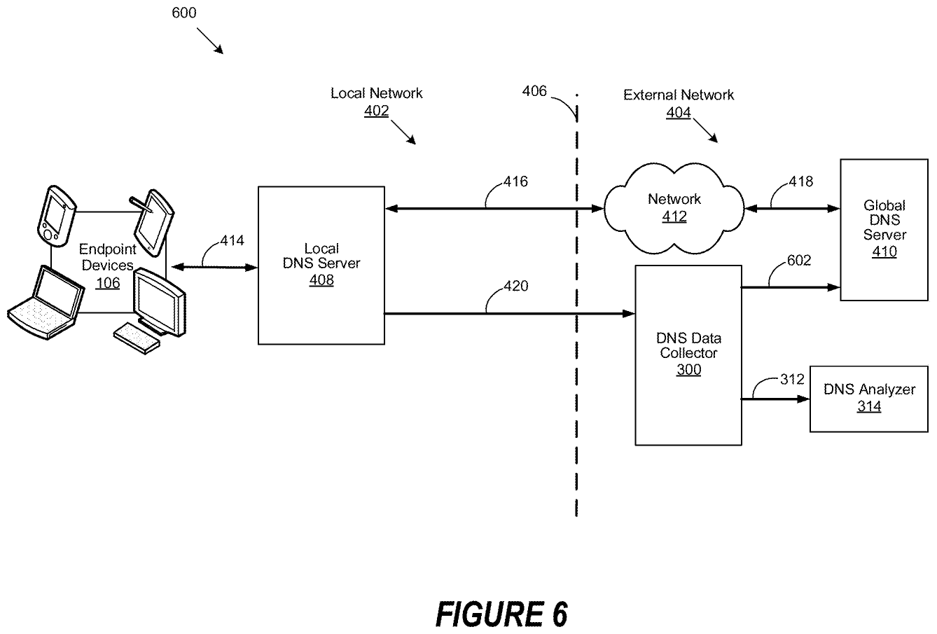

FIG. 6 illustrates a DNS data monitoring system with a DNS data collector in an external network, such as the “cloud.” In certain implementations, the DNS data monitoring system 600 includes local network 402 and external network 404, as defined by line 406. Local network 402 can include customer networks. External network 404 can include the Internet. The local network 402 can include endpoint devices 106 and local DNS server 408, where the local DNS server 408 can be an existing DNS server that is a part of the local network 402. The external network 404 includes global DNS server 410. The global DNS server 410 can be included or connected to network 412. In certain implementations, the network 412 can be a cloud network. In this implementation, the external network 404 includes DNS data collector 300. The external network 404 includes the DNS analyzer 314.

In certain implementations, data flow for the DNS data monitoring system 600 is as follows. Endpoint devices 106 make DNS requests 414 to the local DNS server 408. DNS requests 414 include requests for an IP address, where the DNS server 408 contacts multiple authoritative “nameservers” to get the necessary IP address information. The local DNS server 408 forwards 416 the DNS requests to network 412, which forwards 418 requests to the global DNS server 410. The global DNS server 410 returns 418 and 416 results (e.g., IP addresses) to the local DNS server 408. The local DNS server 408 provides logs 420 to the DNS data collector 300 which is included in external network 404 which can include a cloud network. The DNS data collector 300 actively or periodically queries 602 the global DNS resolver 410 for missing DNS information. The DNS data collector 300 forwards DNS data stream 312 to a DNS analyzer 314 for analysis (e.g., DNS traffic analytics, such as threat analytics).

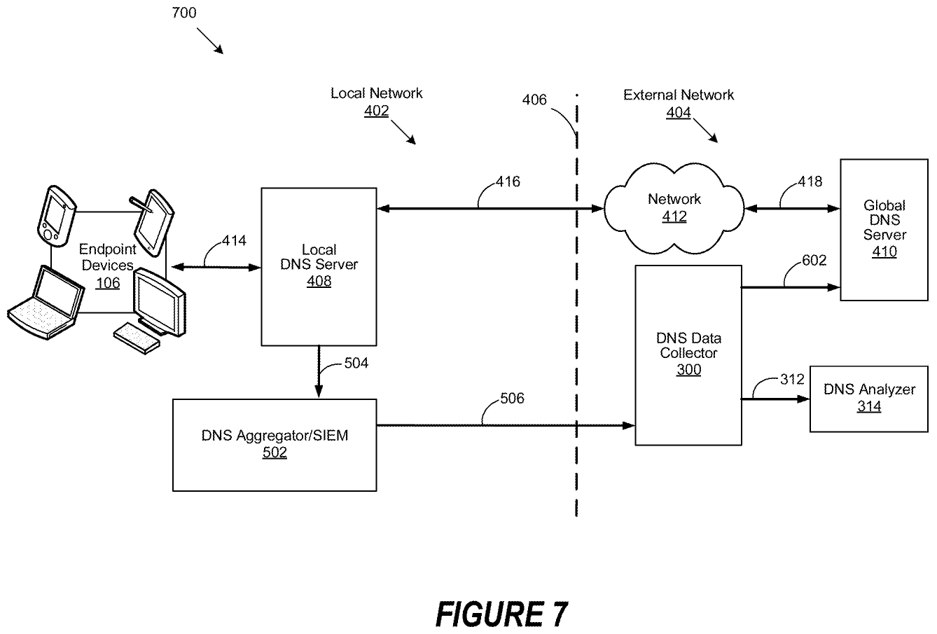

FIG. 7 illustrates a DNS data monitoring system with a DNS data collector in an external network, such as the “cloud”, and a local DNS log aggregator, such as a SIEM. In certain implementations, the DNS data monitoring system 700 includes local network 402 and external network 404, as defined by the line 406. Local network 402 can include customer networks. External network 404 can include the Internet. The local network 402 can include endpoint devices 106 and local DNS server 408, where the local DNS server 408 can be an existing DNS server that is a part of the local network 402. The external network 404 includes a global DNS server 410. The global DNS server 410 can be included or connected to network 412. In certain implementations, the network 412 can be a cloud network. In this implementation, the external network 404 includes DNS data collector 300. The external network 404 includes the DNS analyzer 314. The DNS monitoring system 500 further includes DNS Aggregator/SIEM 502 which can be a separate DNS Aggregator, or a security information and event management or SIEM system/component that includes a DNS Aggregator(s).

In certain implementations, data flow for the DNS data monitoring system 700 is as follows. Endpoint devices 106 make DNS requests 414 to the local DNS server 408. DNS requests 414 include requests for an IP address, where the DNS resolver 408 contacts multiple authoritative “nameservers” to get the necessary IP address information. The local DNS server 408 forwards 416 the DNS requests to network 412, which forwards 418 requests to the global DNS server 410. The global DNS server 410 returns 418 and 416 results (e.g., IP addresses) to the local DNS server 408. The local DNS server 408 provides the results 414 to the requesting endpoint devices 106. The local DNS server 408 provides logs 504 to the DNS Aggregator/SIEM 502. DNS data collector 300 running on external network 404 (e.g., cloud network) collects DNS data 506 from the DNS Aggregator/SIEM 502. The DNS data collector 300 actively or periodically queries 602 the global DNS server 410 for missing DNS information. The DNS data collector 300 forwards DNS data stream 312 to a DNS analyzer 314 for analysis (e.g., DNS traffic analytics, such as threat analytics).

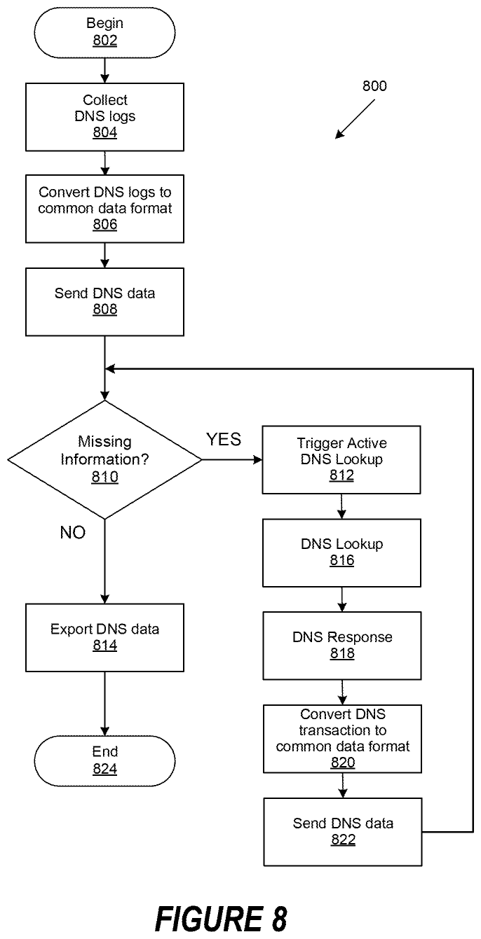

FIG. 8 is a generalized flowchart 800 for obtaining domain name system (DNS) monitoring data. In various embodiments, DNS data monitoring systems as described in FIGS. 4, 5, 6 and 7 can implemented. In particular, the data collector 300 can be implemented. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 802 the process 800 starts. At step 804, collecting DNS logs is performed. DNS logs can be collected from various sources, and particularly from a DNS server(s) which log basic information regarding DNS transactions. Typical DNS logs may not include full request from a device (i.e., endpoint device) and response back to the device. In certain implementations, DNS log collector/parser 302 of FIG. 3 performs step 804.

At step 806, converting to a common data format is performed on the collected DNS logs. The common data format is recognizable by components/elements that further process the collected DNS logs. In certain implementations, DNS log collector/parser 302 of FIG. 3 performs step 804.

At step 808, sending DNS data or information of the converted DNS logs (e.g., transaction information) is performed. In certain implementations, the DNS log collector/parser 302 of FIG. 3 performs step 806, and the DNS data or information is sent to DNS view composer 306 of FIG. 3.

If DNS data or information is missing, following the YES branch of block 810, step 812 is performed. In other words, a more complete DNS log may be desired. If DNS data or information is complete or no additional DNS data is desired, following the NO branch of block 810, step 814 is performed. In certain implementations, the decision block 810 is performed by DNS view composer 306 of FIG. 3.

At step 812, active DNS lookup is triggered. In certain implementations, the step 812 is performed by DNS view composer 306 of FIG. 3. At step 816, DNS lookup is performed. At step 818, receiving DNS information (e.g., transaction information) is performed. At step 820, converting the received DNS information to a common data format is performed. At step 822, sending DNS data or information of the converted DNS logs (e.g., transaction information) is performed to complete DNS logs that are missing data. Missing data may or may not complete the DNS logs. In certain implementations, steps 816, 818, 820 and 822 are performed by Ad Hoc DNS client 304 of FIG. 3. In certain implementations, local and global DNS servers as described in FIGS. 4, 5, 6 and 7 can provide the DNS information.

At step 814, the more complete DNS data information is exported for analysis. In certain implementations, as described in FIGS. 3, 4, 5, 6 and 7, the DNS analyzer 314 can perform analysis from exported data of step 814.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method to obtain domain name system (DNS) monitoring data comprising:
collecting DNS logs from one or more sources;
determining if the collected DNS logs are missing DNS data;
looking up DNS transactions to determine the missing DNS data if the collected DNS logs are missing DNS data;
receiving the missing DNS data to create more complete DNS logs; and
sending the more complete DNS logs for analysis.

2. The method of claim 1, wherein the one or more sources include DNS resolvers and aggregators.

3. The method of claim 1, wherein the one or more sources include DNS servers and aggregators.

4. The method of claim 3, wherein the servers include one of a local DNS server or a global DNS server.

5. The method of claim 3, wherein the aggregators include one of a local aggregator or global aggregator.

6. The method of claim 1, wherein the collecting is performed periodically.

7. The method of claim 1, further comprising converting the DNS logs and DNS data to a common format.

8. The method of claim 1 wherein the DNS transactions comprise a subset of DNS requests.

9. A system comprising:
a processor;
a data bus coupled to the processor; and
a computer-usable medium embodying computer program code, the computer-usable medium being coupled to the data bus, the computer program code used for determining vertically and horizontally aligned cells in a structure data and comprising instructions executable by the processor and, configured for:
collecting DNS logs from one or more sources;
determining if the collected DNS logs are missing DNS data;
looking up DNS transactions to determine the missing DNS data if the collected DNS logs are missing DNS data;
receiving the missing DNS data to create more complete DNS logs; and
sending the more complete DNS logs for analysis.

10. The system of claim 9, wherein the one or more sources include DNS resolvers, servers and aggregators.

11. The system of claim 10, wherein the resolvers include one of a local DNS server or a global DNS server.

12. The system of claim 9, wherein the collecting is performed periodically.

13. The system of claim 9, wherein the computer-usable medium is executable by the processor and further configured for: converting the DNS logs and DNS data to a common format.

14. The system of claim 9, further comprising: DNS data converter comprised of a DNS log collector/parser, Ad Hoc DNS client, and DNS view composer.

15. A non-transitory, computer-readable storage medium embodying computer program code, the computer program code comprising computer executable instructions configured for:
collecting DNS logs from one or more sources;
determining if the collected DNS logs are missing DNS data;
looking up DNS transactions to determine the missing DNS data if the collected DNS logs are missing DNS data;
receiving the missing DNS data to create more complete DNS logs; and
sending the more complete DNS logs for analysis.

16. The non-transitory, computer-readable storage medium of claim 15, wherein the one or more sources include DNS resolvers, servers, and aggregators.

17. The non-transitory, computer-readable storage medium of claim 16, wherein the server include one of a local DNS server or a global DNS server,

18. The non-transitory, computer-readable storage medium of claim 16, wherein the aggregators include one of a local aggregator or global aggregator.

19. The non-transitory, computer-readable storage medium of claim 15, wherein the collecting is performed periodically.

20. The non-transitory, computer-readable storage medium of claim 15, further comprising converting the DNS logs and DNS data to a common format.
